(19) United States
(12) Patent Application Publication
(10) Pub. No.: US 2025/0174224 A1
(43) Pub. Date: May 29, 2025

(54) ESTIMATED KEYWORD LENGTH REFINEMENT BASED ON SPEECH RATE CLASSIFICATION

(71) Applicant: QUALCOMM Incorporated, San Diego, CA (US)

(72) Inventor: Uday Reddy THUMMALURI, Nalgonda (IN)

(21) Appl. No.: 18/521,077

(22) Filed: Nov. 28, 2023

(51) Int. Cl. G10L 15/16; G10L 15/08; G10L 15/34

(52) U.S. Cl. CPC G10L 15/16; G10L 15/34; G10L 2015/088

(57) ABSTRACT

Systems and techniques are provided for processing one or more audio samples. For example, a process can include detecting, using a first keyword detection model, a spoken keyword within an audio sample of the one or more audio samples. Estimated keyword indices corresponding to detection of the spoken keyword within the audio sample can be determined, comprising an estimated keyword start index and an estimated keyword end index. A speech rate classification machine learning network can be used to determine speech rate information corresponding to the audio sample. An average spoken length value corresponding to the spoken keyword and the speech rate information can be obtained. Refined keyword indices can be generated based on the estimated keyword indices and the average spoken length value, wherein the refined keyword indices include a refined keyword start index shifted to a time earlier than the estimated keyword start index

### FIELD

Aspects of the present disclosure generally relate to speech recognition. In some implementations, examples are described for performing multi-stage speech recognition based on using speech rate information to refine estimated keyword indices.

### BACKGROUND

Electronic devices such as smartphones, tablet computers, wearable electronic devices, smart TVs, and the like are becoming increasingly popular among consumers. These devices can provide voice and/or data communication functionalities over wireless or wired networks. In addition, such electronic devices can include other features that provide a variety of functions designed to enhance user convenience. Electronic devices can include a speech recognition function for receiving voice commands from a user. Such a function allows an electronic device to perform a function associated with a voice command (e.g., such as via a keyword) when the voice command from a user is received and recognized. For example, the electronic device may activate a voice assistant application, play an audio file, or take a picture in response to the voice command from the user.

Speech recognition can be implemented as an “always-on” function in electronic devices in order to maximize its utility. These always-on functions require always-on software and/or hardware resources, which in turn lead to always-on power usage. Mobile electronic devices, internet of things (IoT) devices, and the like are particularly sensitive to such always-on power demands as they reduce battery life and consume other finite resources of the system, such as processing capacity.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for processing one or more audio samples. According to at least one illustrative example, a method for processing one or more audio samples is provided. The method may include: detecting, using a first keyword detection model, a spoken keyword within an audio sample of the one or more audio samples; determining estimated keyword indices corresponding to detection of the spoken keyword within the audio sample, the estimated keyword indices comprising an estimated keyword start index and an estimated keyword end index; determining, using a speech rate classification machine learning network, speech rate information corresponding to the audio sample; obtaining an average spoken length value corresponding to the spoken keyword and the speech rate information; and generating refined keyword indices based on the estimated keyword indices and the average spoken length value, wherein the refined keyword indices include a refined keyword start index shifted to a time earlier than the estimated keyword start index and a refined keyword end index shifted to a time later than the estimated keyword end index.

In another illustrative example, an apparatus for processing one or more audio samples is provided. The apparatus includes one or more memories and one or more processors coupled to the one or more memories. The one or more processors are configured to and can: detect, using a first keyword detection model, a spoken keyword within an audio sample of the one or more audio samples; determine estimated keyword indices corresponding to detection of the spoken keyword within the audio sample, the estimated keyword indices comprising an estimated keyword start index and an estimated keyword end index; determine, using a speech rate classification machine learning network, speech rate information corresponding to the audio sample; obtain an average spoken length value corresponding to the spoken keyword and the speech rate information; and generate refined keyword indices based on the estimated keyword indices and the average spoken length value, wherein the refined keyword indices include a refined keyword start index shifted to a time earlier than the estimated keyword start index and a refined keyword end index shifted to a time later than the estimated keyword end index.

In another illustrative example, a non-transitory computer-readable storage medium comprising instructions stored thereon which, when executed by at least one processor, causes the at least one processor to: detect, using a first keyword detection model, a spoken keyword within an audio sample of the one or more audio samples; determine estimated keyword indices corresponding to detection of the spoken keyword within the audio sample, the estimated keyword indices comprising an estimated keyword start index and an estimated keyword end index; determine, using a speech rate classification machine learning network, speech rate information corresponding to the audio sample; obtain an average spoken length value corresponding to the spoken keyword and the speech rate information; and generate refined keyword indices based on the estimated keyword indices and the average spoken length value, wherein the refined keyword indices include a refined keyword start index shifted to a time earlier than the estimated keyword start index and a refined keyword end index shifted to a time later than the estimated keyword end index.

In another illustrative example, an apparatus is provided. The apparatus includes: means for detecting, using a first keyword detection model, a spoken keyword within an audio sample of the one or more audio samples; means for determining estimated keyword indices corresponding to detection of the spoken keyword within the audio sample, the estimated keyword indices comprising an estimated keyword start index and an estimated keyword end index; means for determining, using a speech rate classification machine learning network, speech rate information corresponding to the audio sample; means for obtaining an average spoken length value corresponding to the spoken keyword and the speech rate information; and means for generating refined keyword indices based on the estimated keyword indices and the average spoken length value, wherein the refined keyword indices include a refined keyword start index shifted to a time earlier than the estimated keyword start index and a refined keyword end index shifted to a time later than the estimated keyword end index.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a block diagram illustrating an example speech recognition system, in accordance with some examples;

FIG. 2 is a block diagram illustrating an example keyword detection system, in accordance with some examples;

FIG. 3 is a block diagram illustrating an example feature generator, in accordance with some examples;

FIGS. 4A-4C are diagrams illustrating examples of neural networks, in accordance with some examples;

FIG. 5 is a block diagram illustrating an example of a deep convolutional network (DCN), in accordance with some examples;

FIG. 6 is a diagram illustrating an example of estimated start and end indices for a detected keyword in an audio sample and ground-truth start and end indices for the keyword in the audio sample, in accordance with some examples;

FIG. 7 is a diagram illustrating respective example audio samples associated with a keyword spoken with a fast speech rate, a normal speech rate, and a slow speech rate, in accordance with some examples;

FIG. 8 is a block diagram illustrating an example keyword detection system using keyword length refinement based on speech rate classification information, in accordance with some examples;

FIG. 9 is a block diagram illustrating an example of a speech rate classification network and a keyword indices refinement engine that may be used to implement the keyword detection system of FIG. 8, in accordance with some examples;

FIG. 10 is a flow chart illustrating an example of a process for processing one or more audio samples, in accordance with some examples; and

FIG. 11 is a block diagram illustrating an example of a computing system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Voice recognition generally refers to the discrimination of a human voice by an electronic device in order to perform some function. One type of voice recognition may include keyword detection (e.g., wake word detection). Keyword detection may refer to a technique where a device detects and responds to certain words. For example, many consumer electronic devices may use keyword detection to recognize specific key words to perform certain actions, such as to “wake” a device, to query a device, and/or to cause the device to perform various other functions. Voice recognition can also be used in more complex functionalities, such as “far field” voice recognition (e.g., from a mobile device placed across a room), user identity verification (e.g., by voice signature), voice recognition during other audio output (e.g., detecting a voice command while playing back music on a device or detecting an interrupting command while a smart assistant is speaking), and voice interaction in complex noise environments, such as within moving vehicles. These are just a few examples, and many others are possible.

Voice recognition, like various other processing tasks on electronic devices, requires power and dedicated hardware and/or software to function. Further, voice recognition may be implemented as an “always-on” function (e.g., where audio is continuously monitored for key word detection) to maximize its utility to users of electronic devices with voice recognition functionality. For devices that are plugged in, the power usage of always-on voice recognition functionality is primarily an efficiency consideration, but for power sensitive devices (e.g., battery powered devices, mobile electronic devices, IoT devices, and the like) with always-on voice recognition functionality, power usage may be of more concern. For example, power use from always-on functions can limit the run-time of such devices and reduce capacity for other system processing requirements.

Voice recognition can include voice activity detection. For example, voice activity detection can refer to the detection of a human voice by a computing device in order to perform some function. For instance, keyword detection (e.g., also referred to as keyword recognition and/or keyword spotting (KWS)) is a task of detecting one or more keyword in an audio signal (e.g., an audio signal including human speech or spoken words). For example, keyword detection can be used to distinguish an activation phrase or a specific command from other speech and noise in an audio signal. In some cases, keyword detection systems can target or be utilized by edge devices such as mobile phones and smart speakers. Detected keywords can include single words, compound words, phrases including multiple words, etc. In some cases, keyword detection can be performed based on a set of pre-determined keywords and/or a set of user-defined keywords. In some cases, user-defined keywords can include one or more adaptations, adjustments, etc., that are determined based on specific characteristics of a given user's voice or speech.

Keyword detection can be performed for one or more audio data inputs (e.g., also referred to herein as “audio data,” “audio signals,” and/or “audio samples”). For instance, an audio sample provided to a keyword detection system can be a streaming audio signal. In some examples, keyword detection can be performed for the streaming audio signal in real-time. A streaming audio signal can be recorded by or obtained from a microphone associated with a computing device. Keyword detection can be performed locally or remotely. For example, keyword detection can be performed locally using one or more processors of the same computing device that collects or obtains the streaming audio signal. In some examples, keyword detection can be performed remotely by transmitting the streaming audio signal (or a representation thereof) from the local computing device to a remote computing device (e.g., the local computing device records an audio signal but offloads keyword detection processing tasks to a remote computing device). Performing keyword locally can result in a lower total latency or compute time but a decreased accuracy. Performing keyword remotely can result in a higher latency but an increased accuracy.

For example, local computing devices (e.g., smartphones) often have less computational power than remote computing devices (e.g., cloud computing systems) and therefore may generate keyword detection results with a lower accuracy or overall performance, particularly when subject to the time constraint associated with providing keyword detection results in real-time or near real-time. For example, local computing devices might implement keyword detection models with lower complexity than those implemented on remote computing devices in order to provide real-time keyword detection results. Lower accuracy keyword detection results can include false positives (e.g., identifying a keyword that is not actually present), false negatives (e.g., failing to identify a keyword that is present), and classification errors (e.g., identifying a first keyword as some other keyword).

However, performing keyword detection remotely can introduce a communication latency that may offset the accuracy gains associated with remote keyword detection. For example, remote keyword detection can introduce latency along the communication path from the local computing device to the remote computing device (e.g., the time to transmit the streaming audio signal or a representation thereof to the remote computing device) and along the return communication path from the remote computing device to the local computing device (e.g., the time to transmit the keyword detection results from the remote computing device back to the local computing device).

In some cases, keyword detection can be performed using multiple stages. For instance, multiple stage keyword detection can be used to minimize power consumption associated with performing keyword detection on a power sensitive device (e.g., to minimize power consumption associated with always-on keyword detection performed by a battery powered device such as a smartphone or other mobile computing device). In multiple stage keyword detection, one or more stages can implement a low complexity and low latency keyword detection model and one or more subsequent stages can implement a higher complexity keyword detection model. For example, multi-stage keyword detection can be performed as a two-stage keyword detection. In such an example, a first stage keyword detection model can be a low complexity and low latency keyword detection model. Based on the first stage generating a keyword detection output (e.g., a keyword detection output having a confidence greater than or equal to a first threshold), the second stage keyword detection model can be activated and used to process the same audio sample (e.g., the same audio sample that triggered the detection output of the first stage).

A second stage keyword detection model can be provided as a relatively high complexity keyword detection model (e.g., with the first stage keyword detection model provided as a relatively low complexity keyword detection model). The second stage keyword detection model can be more performant than the first stage keyword detection model. The second stage keyword detection model can be used to provide a double confirmation of a keyword detection (e.g., by validating or confirming the keyword detection of the first stage) or to reject the first stage keyword detection as a false positive (e.g., invalidating the keyword detection of the first stage). However, performing multiple stages of keyword detection and/or using multiple different keyword detection models can also be seen to increase an end-to-end system latency of a keyword detection system.

In some cases, keyword detection may often be performed in real-time (or approximately real-time) to allow user interaction with one or more computing devices. The lag between the time a user speaks a keyword (e.g., an activation phrase or specific command) and the time that the computing device provides a corresponding response or action can be an important factor in the user's willingness to utilize spoken commands (e.g., spoken keywords). In some cases, a lag of multiple seconds may frustrate users or otherwise dissuade them from using spoken keywords. As such, there is a need for improved keyword detection performance (e.g., with decreased latency) in local and/or remote keyword detection implementations, as both local and remote keyword detection implementations are often time-bound processes.

Systems, apparatuses, methods (also referred to as processes), and computer-readable media (collectively referred to herein as “systems and techniques”) are described herein for a keyword detection system that can be used to perform multi-stage keyword detection with improved detection performance and reduced latency. For instance, the systems and techniques can perform multi-stage keyword detection using at least a first keyword detection stage and a second keyword detection stage. The first keyword detection stage can be configured to perform an initial keyword detection and keyword start index estimation. The second keyword detection stage can be configured to implement a more performant and/or more accurate keyword detection of the audio sample corresponding to the keyword from the initial detection of the first stage. In some cases, the systems and techniques can be used to implement a multi-stage keyword detection system for always-on keyword detection and/or other speech recognition tasks.

For instance, the first keyword detection stage can use the keyword start index estimation to determine a time index (e.g., within an audio sample being processed) corresponding to the estimated start of the detected keyword. The keyword start index estimation can be performed after the initial keyword detection. In some aspects, a detection time (e.g., detection time stamp, detection point, etc.) associated with the keyword detection can be used as an estimated end index of the keyword, based at least in part on the particular keyword detection model(s) used to perform the keyword detection. For instance, keyword detection models may implement keyword detection based on the keyword detection occurring at the end of the keyword (e.g., or near the end of the keyword in an input audio stream, etc.). The estimated start of the keyword and/or the estimated end of the keyword can be used to provide a keyword buffer to the second keyword processing stage, where the keyword buffer includes the corresponding portion of the audio sample beginning from the estimated start of the detected keyword.

In one illustrative example, the systems and techniques can include a speech rate classification engine that can be used to process an input audio sample in parallel with the keyword detection and start estimation of the first keyword processing stage. For instance, the speech rate classification engine can be provided as a speech rate classification machine learning network (e.g., neural network, etc.) configured to determine a speech rate of an input audio sample. In some aspects, the speech rate classification engine can classify the speech rate of the input audio sample as corresponding to a fast talker (e.g., a fast speech rate), a normal talker (e.g., a normal speech rate), a slow talker (e.g., a slow speech rate), etc.

In some examples, the first keyword processing stage can include a first machine learning network (e.g., a first neural network) configured to perform keyword detection based on the input audio sample, and can include a second machine learning network (e.g., a second neural network) configured to perform keyword start index estimation for a detected keyword. In some aspects, based on a detected keyword within the input audio sample (e.g., determined using the keyword detection machine learning network of the first stage), the systems and techniques can perform the keyword start index estimation (e.g., using the keyword start index estimation machine learning network of the first stage) and the speech rate classification (e.g., using the speech rate classification machine learning network) in parallel.

A keyword indices refinement engine can be configured to determine refined (e.g., fine-tuned, updated, modified, etc.) start and/or end indices for the detected keyword of the first stage. In one illustrative example, refined keyword start and/or end indices that are closer to the actual or ground-truth indices for the keyword spoken in the input audio sample can improve the performance and/or reduce the latency of the multi-stage keyword detection system. The keyword indices refinement engine can determine the refined keyword start and/or end indices based on the estimated keyword start and end indices determined by the keyword start index estimation network, and based on the speech rate information determined for the input audio sample using the speech rate classification network.

For instance, one or more offline datasets can be used to generate average spoken keyword lengths for each respective keyword of one or more different keywords that are configured for recognition by the multi-stage keyword detection system. For each respective keyword, the offline dataset can be used to generate a corresponding average spoken keyword length information for each respective speech rate classification of a set of one or more possible speech rate classifications that may be output by the speech rate classification network. For instance, where the speech rate classification network can output speech rate information indicative of a fast, normal, or slow speech rate, the offline datasets can be used to generate, for each respective keyword of the one or more different keywords, the average spoken length of the respective keyword by slow speech rate talkers, the average spoken length of the respective keyword by normal speech rate talkers, and the average spoken length of the respective keyword by fast speech rate talkers.

In some examples, the average spoken length information for each respective keyword by the different speech rate talkers can be determined offline, and may be embedded in the machine learning model metadata (e.g., neural network metadata) that is used to configure one or more machine learning models of the multi-stage keyword detection system. Based on embedding the average spoken keyword length information in the machine learning model metadata, the systems and techniques can generate the refined keyword start and end indices by fine-tuning or refining the initial keyword indices estimate to correspond to the detected speech rate classification for the input audio sample.

Further aspects of the systems and techniques will be described with respect to the figures.

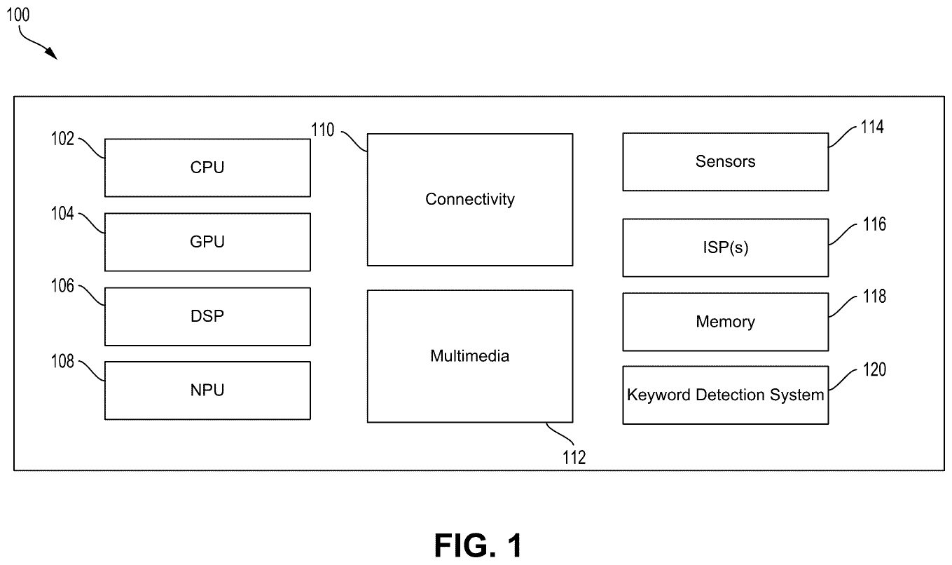

FIG. 1 illustrates an example implementation of a system-on-a-chip (SoC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SoC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures, speech, and/or other interactive user action(s) or input(s). In one implementation, the NPU 108 is implemented in the CPU 102, DSP 106, and/or GPU 104. The SoC 100 may also include a sensor processor 114, image signal processors (ISPs) 116, and/or a keyword detection system 120. In some examples, the sensor processor 114 can be associated with or connected to one or more sensors for providing sensor input(s) to sensor processor 114. For example, the one or more sensors and the sensor processor 114 can be provided in, coupled to, or otherwise associated with a same computing device.

In some examples, the one or more sensors can include one or more microphones for receiving sound (e.g., an audio input), including sound or audio inputs that can be used to perform keyword spotting (KWS), which may be considered a specific type of keyword detection. In some cases, the sound or audio input received by the one or more microphones (and/or other sensors) may be digitized into data packets for analysis and/or transmission. The audio input may include ambient sounds in the vicinity of a computing device associated with the SoC 100 and/or may include speech from a user of the computing device associated with the SoC 100. In some cases, a computing device associated with the SoC 100 can additionally, or alternatively, be communicatively coupled to one or more peripheral devices (not shown) and/or configured to communicate with one or more remote computing devices or external resources, for example using a wireless transceiver and a communication network, such as a cellular communication network.

SoC 100, DSP 106, NPU 108 and/or keyword detection system 120 may be configured to perform audio signal processing. For example, the keyword detection system 120 may be configured to perform steps for KWS. As another example, one or more portions of the steps, such as feature generation, for voice KWS may be performed by the keyword detection system 120 while the DSP 106/NPU 108 performs other steps, such as steps using one or more machine learning networks and/or machine learning techniques according to aspects of the present disclosure and as described herein.

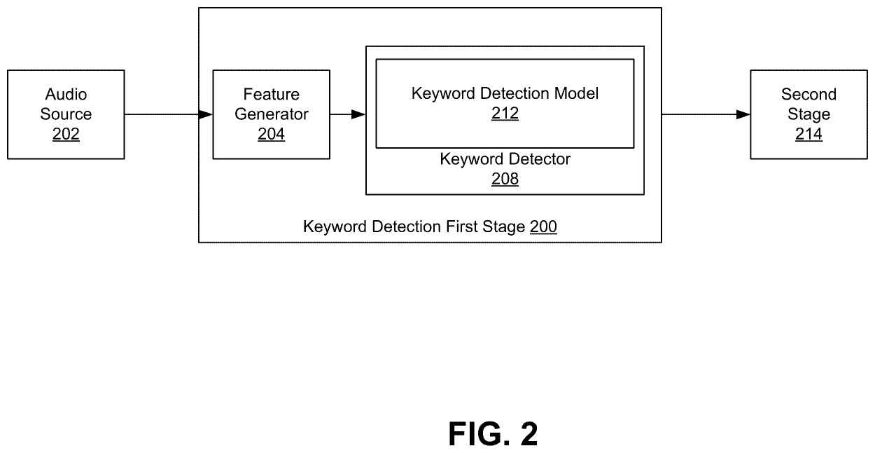

FIG. 2 depicts an example keyword detection first stage 200, in accordance with aspects of the present disclosure. Keyword detection first stage 200 receives audio signals (e.g., pulse-code modulation (PCM) audio data from an analog microphone, pulse density modulation (PDM) high definition audio from a digital microphone, and the like) from an audio source 202 in an electronic system. For example, the audio signals could be generated by one or more microphones of an electronic device, such as a mobile electronic device, smart home device, internet of things (IoT) device, or other edge processing device. In some cases, the audio signal may be received substantially in real time.

In some cases, certain devices, such as relatively low-power (e.g., battery operated) devices may include a two-stage speech recognition system wherein a first keyword detection stage (e.g., the first keyword detection stage 200) generates a keyword detection output that may be used to activate a second keyword detection stage (e.g., second keyword detection stage 214). In multiple stage keyword detection, one or more stages can implement a low complexity and low latency keyword detection model and one or more subsequent stages can implement a higher complexity keyword detection model.

For instance, a model associated with the first keyword detection stage 200 can be a low complexity and low latency keyword detection model. Based on the first stage 200 generating a keyword detection output (e.g., a keyword detection output having a detection score greater than or equal to a first threshold), a model associated with the second keyword detection stage 214 can be activated and used to process the same audio sample (e.g., the same audio sample that triggered the detection output of the first stage 200). The relatively high complexity and/or more performant second stage keyword detection model can be used to provide a double confirmation of a keyword detection (e.g., by validating or confirming the keyword detection of the first stage) or to reject the first stage keyword detection as a false positive (e.g., invalidating the keyword detection of the first stage).

In some cases, the keyword detection first stage 200 may be implemented using a relatively lower-powered circuit such as a DSP, codec circuit, etc. When a keyword is detected, a second stage 214 may be activated which may, for example, handle more complex tasks, such as more freeform word recognition, detecting commands, performing tasks, etc. In some cases, the second stage may be performed on a relatively higher-powered circuit, such as a processor, GPU, ML/AI processor, etc.

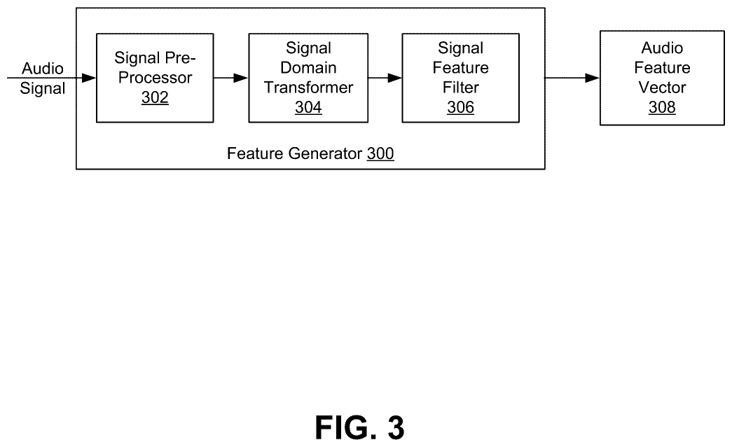

As illustrated in FIG. 2, received audio samples (e.g., audio samples from audio source 202) are processed by a feature generator 204 of the keyword detection first stage 200. Feature generator 204 may be, for example, a hardware-implemented Fourier transformation, such as a fast Fourier transformation (FFT) function or circuit. A Fourier transform is generally a function for deconstructing a time domain representation of a signal, such as the received audio signals, into a frequency domain representation. The frequency domain representation may include voltages or powers present at varying frequencies in the received audio signals. In some cases, the feature generator 204 may generate a set of features, such as a feature vector, based on these representations. This set of features may be output to a keyword detector 208. An example of feature generator 204 is described in more detail with respect to FIG. 3. Notably, other or additional forms of feature generation may be used in other aspects and examples.

Keyword detector 208 may use a keyword detection model 212 to determine whether the received audio signal includes portions of a keyword. In some cases, the keyword detector 208 may accept, as input, tens to hundreds of audio frames per second and the keyword detector 208 may attempt to detect parts of the keyword in an audio signal. In some cases, the keyword detection model 212 of keyword detector 208 may be a part of a multi-stage speech recognition system.

After the keyword detector 208 determines that a keyword was detected in the received audio signal, the keyword detector 208 generates a signal for a second stage 214. For example, a detected keyword may cause an application to launch, or another part of the electronic device to wake up (e.g., a screen, other processor, or other sensor), a query to be run locally or at a remote data service, additional speech recognition processing, and the like. In some aspects, the second stage 214 may receive an indication that keyword has been detected, while in other aspects and/or examples, second stage 214 may receive additional information, such as information specific to the detected keyword, such as one or more detected keywords in the voice activity. Notably, there may be additional functions (not shown) between keyword detector 208 and second stage 214, such as additional stages of keyword detection or analysis.

FIG. 3 depicts an example of a feature generator 300, such as feature generator 204 of FIG. 2, in accordance with aspects of the present disclosure. It should be understood that many techniques may be used to generate feature vectors for an audio and that feature generator 300 is just a single example of a technique that may be used to generate feature vectors.

Feature generator 300 receives an audio signal at signal pre-processor 302. As above, the audio signal may be from an audio source, such as audio source 202, of an electronic device, such a microphone.

Signal pre-processor 302 may perform various pre-processing steps on the received audio signal. For example, signal pre-processor 302 may split the audio signal into parallel audio signals and delay one of the signals by a predetermined amount of time to prepare the audio signals for input into an FFT circuit.

As another example, signal pre-processor 302 may perform a windowing function, such as a Hamming, Hann, Blackman-Harris, Kaiser-Bessel window function, or other sine-based window function, which may improve the performance of further processing stages, such as signal domain transformer 304. Generally, a windowing (or window) function in may be used to reduce the amplitude of discontinuities at the boundaries of each finite sequence of received audio signal data to improve further processing.

As another example, signal pre-processor 302 may convert the audio signal data from parallel to serial, or vice versa, for further processing. The pre-processed audio signal from the signal pre-processor 302 may be provided to signal domain transformer 304, which may transform the pre-processed audio signal from a first domain into a second domain, such as from a time domain into a frequency domain.

In some aspects, signal domain transformer 304 implements a Fourier transform, such as a fast Fourier transform (FFT). For example, in some cases, the fast Fourier transform may be a 16-band (or bin, channel, or point) FFT, which generates a compact feature set that may be efficiency processed by a model. In some cases, a Fourier transform provides fine spectral domain information about the incoming audio signal as compared to conventional single channel processing, such as conventional hardware SNR threshold detection. The result of signal domain transformer 304 is a set of audio features, such as a set of voltages, powers, or energies per frequency band in the transformed data.

The set of audio features may then be provided to signal feature filter 306, which may reduce the size of or compress the feature set in the audio feature data. In some aspects, signal feature filter 306 may discard certain features from the audio feature set, such as symmetric or redundant features from multiple bands of a multi-band FFT. Discarding this data reduces the overall size of the data stream for further processing and may be referred to a compressing the data stream.

For example, in some cases, a 16-band FFT may include 8 symmetric or redundant bands of after the powers are squared because audio signals are real. Thus, signal feature filter 306 may filter out the redundant or symmetric band information and output an audio feature vector 308. In some cases, output of the signal feature filter may be compressed or otherwise processed prior to output as the audio feature vector 308.

The audio feature vector 308 may be provided to a keyword detector for processing by a keyword detection model, such as keyword detector 208 and keyword detection model 212 as shown in FIG. 2.

In some cases, the voice detection model, such as keyword detection model 212, may execute on SoC 100 and/or components thereof, such as the DSP 106 and/or the NPU 108 of FIG. 1. In some cases, the voice detection model may be a machine learning model or system.

Machine learning (ML) can be considered a subset of artificial intelligence (AI). ML systems can include algorithms and statistical models that computer systems can use to perform various tasks by relying on patterns and inference, without the use of explicit instructions. One example of a ML system is a neural network (also referred to as an artificial neural network), which may include an interconnected group of artificial neurons (e.g., neuron models). Neural networks may be used for various applications and/or devices, such as speech analysis, audio signal analysis, image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is one example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

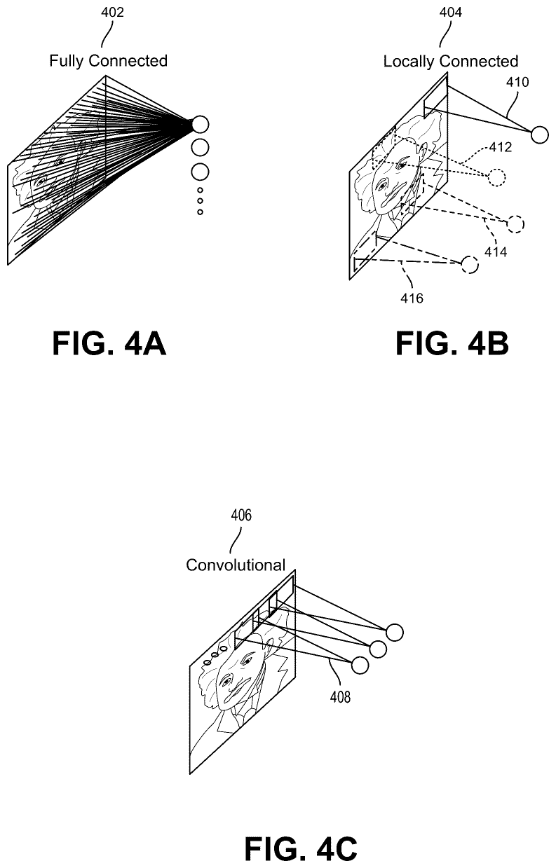

FIGS. 4A-4C illustrate example neural networks which may be used for keyword detection, in accordance with aspects of the present disclosure. Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

In some cases, the connections between layers of a neural network may be fully connected or locally connected. FIG. 4A illustrates an example of a fully connected neural network 402. In a fully connected neural network 402, a neuron in a first layer may communicate its output to every neuron in a second layer, so that each neuron in the second layer will receive input from every neuron in the first layer. FIG. 4B illustrates an example of a locally connected neural network 404. In a locally connected neural network 404, a neuron in a first layer may be connected to a limited number of neurons in the second layer. More generally, a locally connected layer of the locally connected neural network 404 may be configured so that each neuron in a layer will have the same or a similar connectivity pattern, but with connections strengths that may have different values (e.g., 410, 412, 414, and 416). The locally connected connectivity pattern may give rise to spatially distinct receptive fields in a higher layer, as the higher layer neurons in a given region may receive inputs that are tuned through training to the properties of a restricted portion of the total input to the network.

One example of a locally connected neural network is a convolutional neural network. FIG. 4C illustrates an example of a convolutional neural network 406. The convolutional neural network 406 may be configured such that the connection strengths associated with the inputs for each neuron in the second layer are shared (e.g., 408). Convolutional neural networks may be well suited to problems in which the spatial location of inputs is meaningful.

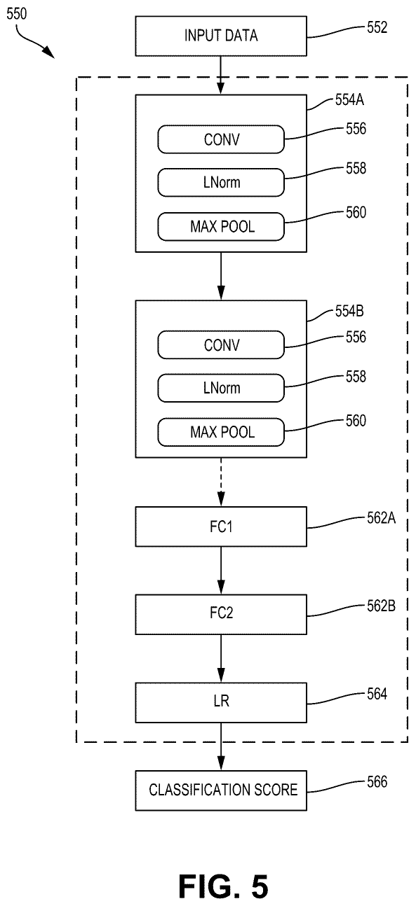

FIG. 5 is a block diagram illustrating an example of a deep convolutional network (DCN) 550, in accordance with aspects of the present disclosure. The DCN 550 may include multiple different types of layers based on connectivity and weight sharing. As shown in FIG. 5, the DCN 550 includes the convolution blocks 554A, 554B. Each of the convolution blocks 554A, 554B may be configured with a convolution layer (CONV) 556, a normalization layer (LNorm) 558, and a max pooling layer (MAX POOL) 560.

The convolution layers 556 may include one or more convolutional filters, which may be applied to the input data 552 to generate a feature map. Although only two convolution blocks 554A, 554B are shown, the present disclosure is not so limiting, and instead, any number of convolution blocks (e.g., blocks 554A, 554B) may be included in the DCN 550 according to design preference. The normalization layer 558 may normalize the output of the convolution filters. For example, the normalization layer 558 may provide whitening or lateral inhibition. The max pooling layer 560 may provide down sampling aggregation over space for local invariance and dimensionality reduction.

The parallel filter banks, for example, of a deep convolutional network may be loaded on a CPU 102 or GPU 104 of an SOC 100 to achieve high performance and low power consumption. In some examples, the parallel filter banks may be loaded on the DSP 106 or an ISP 116 of an SOC 100. In addition, the DCN 550 may access other processing blocks that may be present on the SOC 100, such as sensor processor 114 and keyword detection system 120, dedicated, respectively, to sensors and navigation.

The deep convolutional network 550 may also include one or more fully connected layers, such as layer 562A (labeled “FC1”) and layer 562B (labeled “FC2”). The DCN 550 may further include a logistic regression (LR) layer 564. Between each layer 556, 558, 560, 562A, 562B, 564 of the DCN 550 are weights (not shown) that are to be updated. The output of each of the layers (e.g., 556, 558, 560, 562A, 562B, 564) may serve as an input of a succeeding one of the layers (e.g., 556, 558, 560, 562A, 562B, 564) in the deep convolutional network 550 to learn hierarchical feature representations from input data 552 (e.g., images, audio, video, sensor data and/or other input data) supplied at the first of the convolution blocks 554A.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new input and a forward pass through the network may yield an output 422 that may be considered an inference or a prediction of the DCN.

The output of the DCN 550 is a classification score 566 for the input data 552. The classification score 566 may be a probability, or a set of probabilities, where the probability is the probability of the input data including a feature from a set of features the DCN 550 is trained to detect.

In some cases, a ML system or model may be used to analyze each audio frame to determine whether a voice command may be present. For keyword detection, the output of the ML network, such as the probability may be referred to as a frame score. This frame score indicates a likelihood that the frame includes one or more portions of a voice command, such as a keyword. As an example, where keyword detection responds to the keyword “hey device,” a first audio frame may have an audio signal that includes sounds corresponding to “he.” The ML network, should output a higher frame score for the first audio frame as compared to another audio frame which does not have an audio signal that includes sounds corresponding to parts of “hey device.” While discussed in the context of a ML system herein, in some cases, a non-ML technique may be used to analyze audio frames to generate frame scores and determine whether a voice command may be present. For example, a Gaussian mixture model (GMM), hidden Markov model (HMM) (GMM-HMM), dynamic time warping (DTW), and/or other processes like phoneme likelihood estimation, Viterbi decoding, etc. using Gaussian acoustic models and/or N-gram language models may be used. These non-ML techniques may also be skipped based on techniques discussed herein.

As noted previously, systems and techniques are described herein for providing a keyword detection system that can be used to perform multi-stage keyword detection with improved detection performance and reduced latency. For instance, the systems and techniques can be used to improve the detection performance and/or reduce the latency associated with multi-stage keyword detection based on determining refined keyword start and/or end indices using speech rate classification information corresponding to the input audio sample in which the keyword was initially detected. Based on refining the keyword start and/or end indices to be closer to the actual (e.g., ground-truth) keyword start index and/or keyword end index (respectively), detection performance can be improved and/or latency can be reduced by reducing the portion of the audio sample that is buffered (e.g., using a keyword buffer) for processing by the second stage keyword detection model(s). For instance, refinement of the keyword start and/or end indices can be used to reduce keyword chopping from a first keyword detection stage, in examples where the first keyword detection stage utilizes incorrect or inaccurate estimated keyword start or end indices. By determining and utilizing refined keyword start and/or end indices after a first keyword estimation stage, a more accurate keyword buffer can be provided to a second keyword detection stage that is downstream (e.g., subsequent to) from the first keyword detection stage. In examples where the chopped keyword buffer is sent to the second keyword detection stage (e.g., without keyword start and/or end indices refinement), the second keyword detection stage can generate a rejection based on the partial keyword utterance within the chopped keyword buffer.

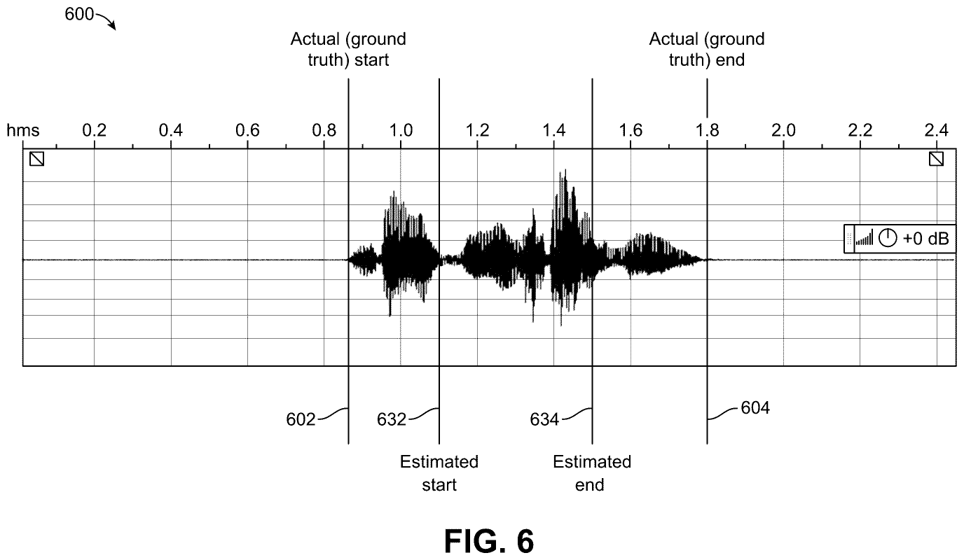

FIG. 6 is a diagram illustrating a keyword audio sample 600 and an example of estimated start and end indices for a detected keyword within the audio sample, and ground-truth start and end indices for the keyword within the audio sample.

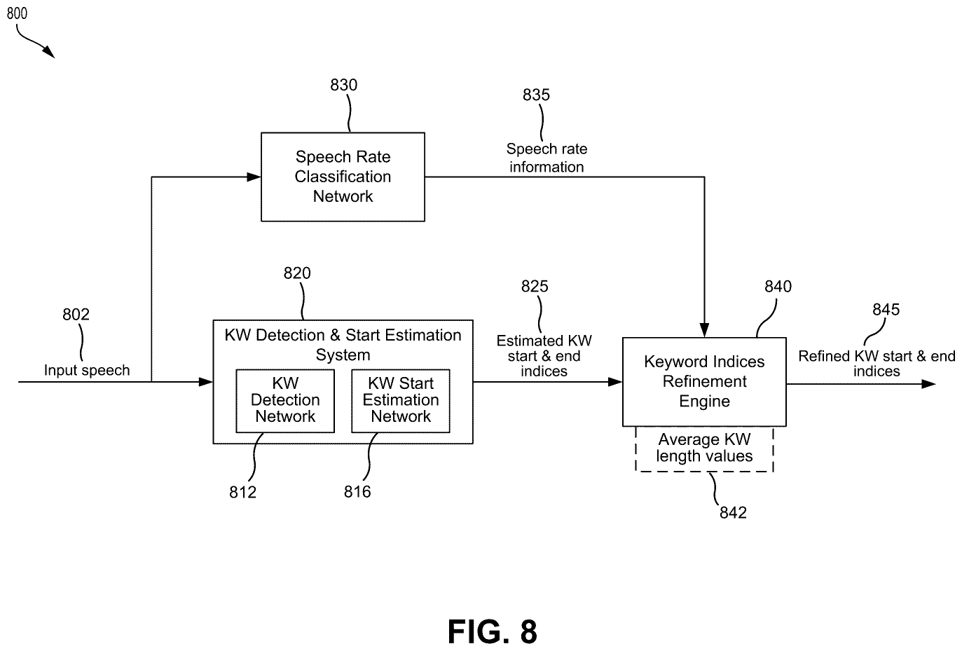

For instance, an estimated keyword start index 632 corresponds to a keyword start time that is estimated by a keyword start estimation machine learning network and/or that is estimated by a first stage of a multi-stage keyword detection system. For instance, the estimated keyword start index 632 may be determined using a keyword detection first stage that is the same as or similar to the keyword detection first stage 200 of FIG. 2, etc. In some examples, the estimated keyword start index 632 may be determined using a keyword start estimation network that is the same as or similar to the keyword start estimation network 816 included in the keyword detection and start estimation system (e.g., keyword processing first stage) 820 of FIG. 8.

An estimated keyword end index 634 may correspond to an estimated keyword end time within the audio sample 600. In some examples, the estimated keyword end index 634 can be the same as the time stamp where initial first stage keyword detection was performed. For instance, the estimated keyword end index 634 can be the time stamp corresponding to an initial keyword detection output generated by the first keyword processing stage, indicative of a successful initial detection of the keyword within the audio sample 600. In some examples, multi-stage keyword processing and detection may be performed without explicit processing to determine or identify the keyword end time (e.g., estimated keyword end index 634).

The estimated keyword start index 632 can be later than the actual (e.g., ground truth) keyword start index 602, which corresponds to the time index where the keyword first begins to be spoken or represented within the audio sample 600. For instance, the difference between the estimated keyword (KW) start index 632 and the actual KW start index 602 can represent the error or differential in the keyword start estimation performed by the first keyword processing stage.

The estimated KW end index 634 can be earlier than the actual (e.g., ground truth) KW end index 604, which corresponds to the time index where the keyword is no longer being spoken or represented within the audio sample 600. The estimated KW end index 634 can be earlier than the actual KW end index 604, based on the estimated KW end index 634 being the same as the timestamp where the keyword detection reaches a threshold level of detection confidence that allows the keyword detection process to exit. For instance, in examples where the keyword detection can be performed using only a portion of the full keyword spoken in an input audio sample, the first keyword detection stage can exit early (e.g., relative to the actual KW end index 604) and the estimated KW end index 634 will be early. The difference between the estimated KW end index 634 and the actual KW end index 604 can represent the error or differential in a keyword end time estimation for the audio sample 600.

As noted previously, multi-stage keyword detection can be performed using at least a first keyword detection stage (e.g., such as keyword detection first stage 200 of FIG. 2) and a second keyword detection stage (e.g., such as second stage 214 of FIG. 2). The first keyword detection stage can be configured to perform an initial keyword detection and keyword start index estimation. The second keyword detection stage can be configured to implement a more performant and/or more accurate keyword detection of the audio sample corresponding to the keyword from the initial detection of the first stage.

In some cases, the first keyword detection stage can use the estimated KW start index 632 to configure a keyword buffer to include the relevant portion of the audio sample 600 that corresponds to the keyword detected by the first keyword detection stage. For instance, the first keyword detection stage can process the audio sample 600 to perform initial keyword detection of a configured keyword. At the time index 634 within the audio sample 600, the first keyword detection stage determines that the keyword is detected within the audio sample 600, and sets the time of keyword detection equal to the estimated KW end index 634.

Subsequently (e.g., after detection of the keyword), the first keyword detection stage can perform keyword start estimation to determine the estimated KW start index 632 for the detected keyword within the audio sample 600.

Using the estimated KW start index 632 and the estimated KW end index 634, the first keyword detection stage can configure the keyword buffer to include the portion of the audio sample 600 between estimated KW start index 632 and estimated KW end index 634, and the keyword buffer is sent to the second keyword detection stage to be processed.

In existing techniques, based on the estimated KW start and/or end indices often deviating from the actual, ground-truth KW start and/or end indices, keyword buffering between the first and second keyword detection stages can be padded to include audio data of the audio sample 600 that is outside of the estimated KW start index 632 (e.g., earlier than the estimated KW start time 632) and/or that is outside of the estimated KW end index 634 (e.g., later than the estimated KW end time 634).

For instance, keyword buffer padding between keyword detection stages may be performed using a configured and/or static padding value indicative of the additional time range or time window of audio data of the audio sample 600 that is outside of the estimated KW indices 632, 634 but should be included in the keyword buffer provided to the second keyword detection stage.

In some examples, the configured static value for padding the keyword buffer start and/or end indices can be inefficient and increase latency of the keyword detection system, such as in cases where the buffer padding value is larger than the actual error between estimated and actual start indices 632 and 602 (respectively) and/or is larger than the actual error between the estimated and actual end indices 634 and 604 (respectively). Processing the additional audio data within the padded portions of the keyword buffer can increase the latency of the second keyword detection stage. For example, an overly padded keyword buffer can have a padded KW start time that is earlier than the actual, ground-truth start time 602 of the keyword within the audio sample 600. The second keyword detection stage may begin processing from the start of the padded keyword buffer (e.g., the earliest audio data within the keyword buffer, which corresponds to a timestamp that is before the actual KW start time 602). Using the second keyword detection stage to process “dead” audio data that occurs before even the true start time 602 of the keyword can be inefficient and increases overall latency of the multi-stage keyword detection system.

In other examples, the configured static value for padding the keyword buffer start and/or end indices can be smaller than the actual error between the estimated and actual KW start indices 632 and 602 (respectively) and/or smaller than the actual error between the estimated and actual KW end indices 634 and 604 (respectively). In some cases, the estimated KW start index 632 may be more likely to experience a significant deviation from the ground truth KW start index 602, and the padded keyword buffer does not include the entirety of the audio data within audio sample 600 that corresponds to (e.g., is between) the actual keyword start index 602 and the actual keyword end index 604.

For instance, based on the configured static value for padding the keyword buffer being smaller than at least the error in the keyword start index estimate (e.g., estimated KW start 632—actual KW start 602), the padded keyword buffer will include only a partial representation of the spoken keyword within audio sample 600 (e.g., the beginning of the spoken keyword within audio sample 600 is clipped from the audio data that is written to the keyword buffer and processed by the second keyword detection stage). An incomplete representation of the spoken keyword audio data in the keyword buffer provided to the second keyword detection stage can cause the second keyword detection stage to incorrectly reject the keyword detection of the first stage (e.g., partial phrase rejection, based on clipping of the keyword audio data within the keyword buffer). Partial phrase rejection and/or rejection of the first stage keyword detection can decrease keyword detection performance, and can harm the user experience, as the keyword will not be recognized within the current audio sample 600 and must instead be spoken again in the future to trigger the desired action.

In one illustrative example, the systems and techniques described herein can be used to implement improved keyword detection (e.g., including multi-stage keyword detection) based on using estimated keyword length refinement from speech rate classification information. For instance, estimated keyword start indices (e.g., such as estimated KW start index 632) and/or estimated keyword end indices (e.g., such as estimated KW end index 634) can be fine-tuned or refined to obtain a keyword buffer audio data that corresponds to a speech rate associated with the spoken keyword within the audio sample 600.

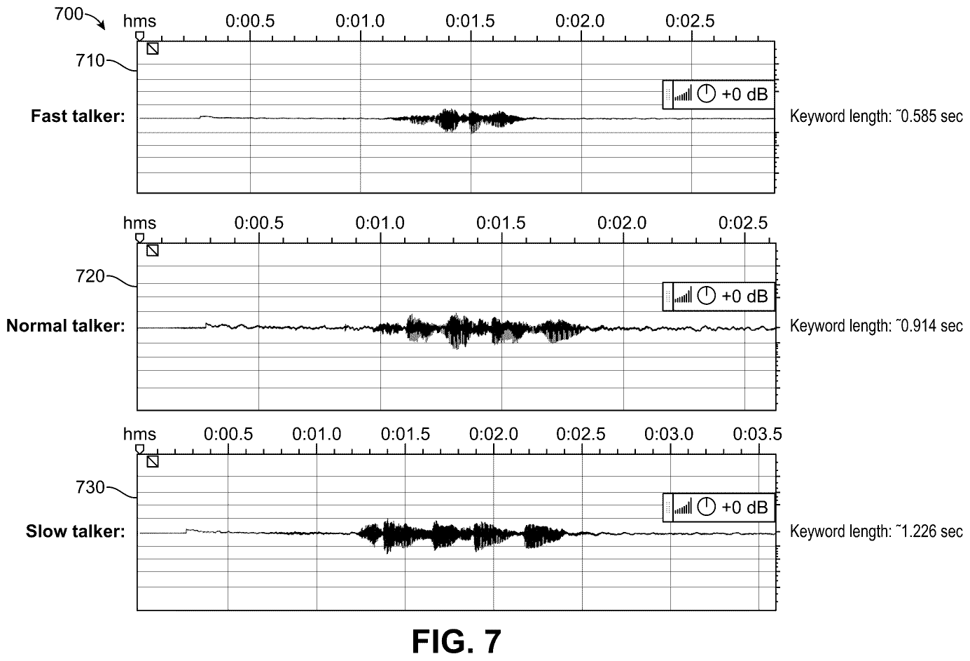

FIG. 7 is a diagram illustrating examples of various speech rates 700 that can be associated with and/or classified for a spoken keyword within an input audio sample. For instance, a first audio sample 710 corresponds to an example of a keyword spoken by a fast talker with a fast speech rate, with a spoken keyword length of approximately 0.585 seconds.

A second audio sample 720 corresponds to an example of the same keyword spoken by a normal talker with a normal speech rate, with a spoken keyword length of approximately 0.914 seconds.

A third audio sample 730 corresponds to an example of the same keyword spoken by a slow talker with a slow speech rate, with a spoken keyword length of approximately 1.226 seconds.

In some cases, the estimated length information for a particular keyword can vary for different speakers, talkers, individuals, users, etc. For instance, the audio samples 710, 720, and 730 each correspond to the same keyword being spoken, and a difference in the spoken keyword length between the fast talker (e.g., audio sample 710) and the slow talker (e.g., audio sample 730) is approximately 0.641 seconds, as the spoken keyword length for the slow talker of audio sample 730 is more than 100% longer than the spoken keyword length for the same keyword being uttered by the fast talker of audio sample 710.

FIG. 8 is a block diagram illustrating an example keyword detection system 800 using keyword length refinement based on speech rate classification information, in accordance with some examples.

The keyword detection system 800 can be used to process and perform keyword detection for audio data corresponding to input speech 802 (e.g., also referred to as “input audio sample 802” or “input audio samples 802”). A keyword detection and start estimation system 820 can include a keyword detection machine learning network 812 (e.g., a first neural network, etc.) and a keyword start estimation machine learning network 816 (e.g., a second neural network, etc.). In some aspects, the keyword detection and start estimation system 820 can be implemented as or by a first keyword detection stage (e.g., and the keyword detection system 800 can be included in or provided as a multi-stage keyword detection system). For instance, the keyword detection and start estimation system 820 can be the same as or similar to the first keyword detection stage 200 of FIG. 2, etc.

The keyword detection network 812 can be used to process the input audio sample 802 and perform an initial keyword detection indicative of a particular keyword that is detected within the input audio sample 802. The particular keyword detected by the keyword detection network 812 can be a configured keyword associated with the keyword detection system 800. In some examples, the particular keyword detected by the keyword detection network 812 can be included in one or more (or a plurality) of configured keywords for detection by the keyword detection system 800.

Based on using the keyword detection network 812 and/or the keyword detection and start estimation system 820 to detect the particular keyword within the input audio sample 802, the keyword start estimation network 816 can be used to determine an estimated start time of the detected keyword within the input audio sample. For instance, the keyword start estimation network 816 can generate estimated keyword start index 825, which can include an estimated keyword start time index that is the same as or similar to the estimated keyword start index 632 of FIG. 6.

In some cases, an estimated keyword end time index associated with the estimated KW start index 825 can be the same as or similar to the estimated keyword end index 634 of FIG. 6. In some examples, the keyword start estimation network 816 can be used to generate the estimated keyword start time index comprising the estimated KW start index 825, and the time of the keyword detection output generated by keyword detection network 812 can be used as the estimated keyword end time index associated with the estimated KW start index 825.

Based on detecting the particular keyword within the input audio sample 802 (e.g., using the keyword detection network 812), the systems and techniques can process the input audio sample 802 in parallel, using a speech rate classification network 830 to determine speech rate information 835 indicative of the speech rate (e.g., fast, normal, slow, etc.) of the spoken keyword within the input audio sample 802. In some cases, the speech rate classification network 830 can be a machine learning classification network trained to classify an input audio sample (e.g., such as input audio sample 802) into one of a plurality of different speech rate classifications, such as fast speech/talker, normal speech/talker, slow speech/talker, etc.

The speech rate classification network 830 can analyze the input audio sample 802 in parallel with the keyword detection and start estimation system 820. In one illustrative example, the speech rate classification network 830 can analyze the input audio sample 802 to generate the speech rate information 835 in parallel with the estimated keyword start index 825 generated using the keyword detection and start estimation system (e.g., first keyword detection stage). For instance, the keyword detection network 812 may be configured to run constantly to perform always-on keyword detection.

A keyword detection by the keyword detection network 812 of the first keyword processing stage 820 can trigger the speech rate classification network 830 and the keyword start estimation network 816 to begin processing the input audio sample 802, where the processing of input audio sample 802 by the network 830 and the network 816 can be performed in parallel.

In some aspects, the keyword detection system 800 can include a keyword indices refinement engine 840, configured to generate refined keyword start and end indices 845 based on the estimated keyword start index 825, the speech rate classification information 835, and further based on average keyword length values 842.

The average keyword length values 842 can correspond to the particular keyword that is detected as a spoken word within the input audio sample 802 (e.g., the average keyword length values 842 can correspond to the particular keyword detected by the keyword detection network 812). The average keyword length values 842 can include an average spoken length of the particular keyword for each respective speech rate classification that is included in the speech rate classification output space of the speech rate classification network 830.

For instance, if the possible output classifications of different speech rates that may be indicated by the speech rate classification network 830 in the speech rate information 835 comprises {fast; normal; slow}, the average keyword length values 842 for the particular keyword detected by the keyword detection network 812 within input audio sample 802 can comprise {average spoken KW length for fast speech rate classification; average spoken KW length for normal speech rate classification; average spoken KW length for slow speech rate classification}.

In some aspects, the average keyword length values 842 can be determined for each respective speech rate classification and for each respective keyword of a plurality of keyword configured for detection and/or recognition by the keyword detection system 800. The average keyword length values 842 can be determined using one or more offline datasets that include a plurality of samples of the plurality of keywords being spoken by talkers with the different respective speech rate classifications.

In one illustrative example, the average keyword length values 842 can be embedded in a machine learning model (e.g., neural network model) used to implement the keyword indices refinement engine 840 and/or used to implement the speech rate classification network 830. For instance, the average keyword length values 842 can be embedded in the model metadata used to configure or initialize the underlying trained machine learning models (e.g., trained neural network models) associated with the keyword detection system 800.

Based on the speech rate information 835, indicating whether the talker of the spoken keyword detected in the input audio sample 802 is a fast, normal, or slow talker, the keyword indices refinement engine 840 can generate the refined keyword start and end indices 845 based on adjusting (e.g., padding) around one or more (or both) of the estimated KW start index 825 and/or an estimated keyword end index associated with the keyword start index 825. For instance, the adjustment or padding of the estimated KW start and end indices can be based on the detected speech rate classification 835 determined by the speech rate classification network 830.

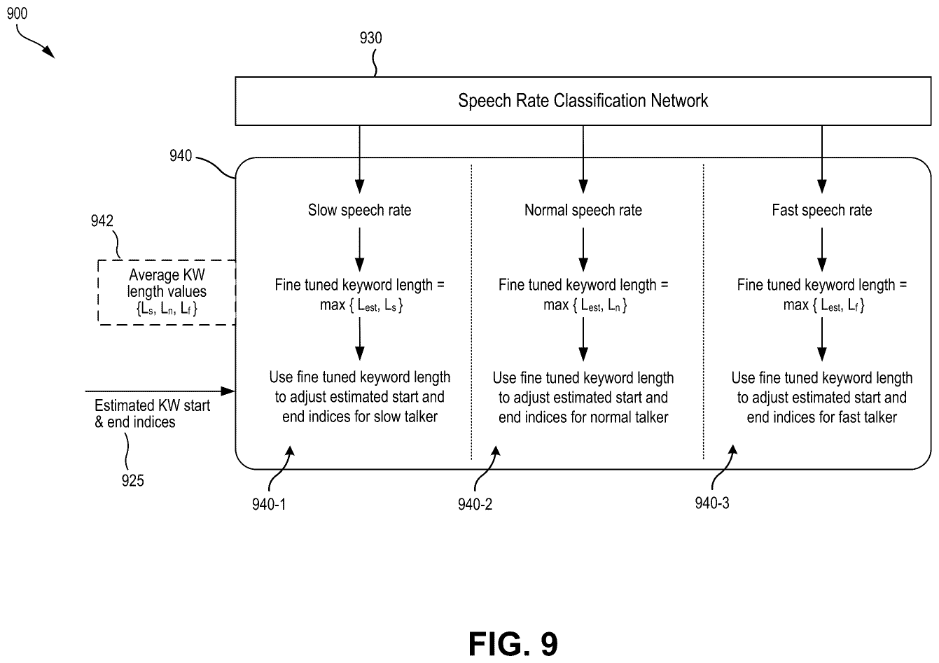

For example, FIG. 9 is a block diagram 900 illustrating an example of a speech rate classification network 930 and a keyword indices refinement engine 940 that may be used to implement the keyword detection system 800 of FIG. 8, in accordance with some examples. In some aspects, the speech rate classification network 930 can be the same as or similar to the speech rate classification network 830 of FIG. 8. In some cases, the keyword indices refinement engine 940 can be the same as or similar to the keyword indices refinement engine 840 of FIG. 8. In some examples, the average keyword length values 942 can be the same as or similar to the average keyword length values 842 of FIG. 8. In some cases, the estimated keyword start index 925 can be the same as or similar to the estimated keyword start index 825 of FIG. 8.

The average keyword length values 942 can be offline average keyword lengths determined for the particular keyword that is detected (e.g., the particular keyword associated with the estimated keyword start and end indices 925), and across each speech rate classification within the classification space of the speech rate classification network.

For instance, in an example where the speech rate classification network 930 includes an output classification space of slow speech rate (e.g., corresponding to the processing flow 940-1 within the keyword indices refinement engine 940), normal speech rate (e.g., corresponding to the processing flow 940-2 within the keyword indices refinement engine 940), and fast speech rate (e.g., corresponding to the processing flow 940-3 within the keyword indices refinement engine 940), the average keyword length values 942 can correspond to the average slow, normal, and fast spoken length of the detected keyword.

In one illustrative example, the average keyword length values 942 can include an offline estimated average keyword length of slow talkers uttering the particular keyword that is detected, represented as Lₛ; an offline estimated average keyword length of normal talkers uttering the particular keyword that is detected, represented as Ln; and an offline estimated average keyword length of fast talkers uttering the particular keyword that is detected, represented as L_{f}.

For instance, the average slow talker keyword length Lₛ can be the same as or similar to the slow talker keyword length 730 of FIG. 7. The average normal talker keyword length Ln can be the same as or similar to the normal talker keyword length 720 of FIG. 7. The average fast talker keyword length L_{f} can be the same as or similar to the fast talker keyword length 710 of FIG. 7.

In some aspects, the keyword indices refinement engine 940 of FIG. 9 can receive as input the estimated keyword start and end indices 925 for the currently detected keyword (e.g., the same keyword corresponding to the average keyword length values 942, which may be embedded in the model metadata of the keyword indices refinement engine 940 and/or the speech rate classification network 930). The estimated keyword start and end indices 925 can be obtained from a first keyword detection stage, such as the keyword detection and start estimation system 820 of FIG. 8, the first keyword detection stage 200 of FIG. 2, etc.

The keyword indices refinement engine 940 can determine the estimated length of the spoken keyword as detected by the estimated keyword start and end indices 925 from the first keyword detection stage. For instance, the keyword indices refinement engine 940 can calculate an estimated spoken keyword length as Lₑₛₜ=estimated KW end timestamp-estimated KW start timestamp. The estimated KW end timestamp and the estimated KW start timestamp can be the same as the estimated KW start and end indices 925.

Based on the speech rate classification network 930 generating speech rate classification information (e.g., such as speech rate classification information 835 of FIG. 8) indicative of a slow speech rate, the keyword indices refinement engine 940 can use the processing flow 940-1 to refine or fine-tune the estimated KW start and end indices 925 based on the average slow talker keyword length Lₛ embedded in the model metadata average keyword length information 942. For instance, the keyword indices refinement engine 940 can calculate a slow speech rate fine-tuned keyword length as max {Lₑₛₜ, Lₛ}, and may use the fine-tuned keyword length to adjust one or more (or both) of the estimated KW start and/or the estimated KW end indices 925. For example, if the estimated spoken keyword length Lₑₛₜ determined from the initial KW start and end indices 925 is longer than the average slow talker spoken keyword length Lₛ, the initial estimated KW start and end indices 925 can be used as the refined KW start and end indices output by the keyword indices refinement engine 940 (e.g., the same as or similar to the refined KW start and end indices 845 output by the keyword indices refinement engine 840 of FIG. 8). If the estimated spoken keyword length Lₑₛₜ from the initial indices estimate 925 is shorter than the average slow talker spoken keyword length Lₛ, the initial estimated KW start and end indices 925 can be adjusted such that (refined KW end index)—(refined KW start index)=Lₛ.

In some examples, the refined KW start and end indices may each be shifted an equal amount of time from their respective initial KW start and end indices 925. For instance, the refined KW start index can be shifted to be earlier than the initial KW start index 925 by an amount equal to

$$\frac{{L}_{s} - {L}_{e s t}}{2}$$

and the refined KW end index can be shifted to be later than the initial KW end index 925 by an amount also equal

$$\frac{{L}_{s} - {L}_{e s t}}{2}$$

(e.g., for a total increase in refined keyword length of Lₛ−Lₑₛₜ, and a refined keyword length equal to Lₛ). In some cases, the estimated KW start and end indices 925 may be non-proportionally or unequally adjusted to generate the corresponding refined KW start and end indices. For instance, the refined KW start index can be shifted to be earlier than the initial KW start index 925 by an amount equal to N(Lₛ−Lₑₛₜ) and the refined KW end index can be shifted to be later than the initial KW end index 925 by an amount equal to (1−N)(Lₛ−Lₑₛₜ), for a total increase in refined keyword length of Lₛ−Lₑₛₜ, and a refined keyword length equal to Lₛ. In one illustrative example, the weighting parameter N can be between 0.5 and 1 (e.g., as the initial KW end index estimate may be more accurate than the initial KW start index estimate of the estimated indices 925)

In another example, based on the speech rate classification network 930 generating speech rate classification information (e.g., such as speech rate classification information 835 of FIG. 8) indicative of a normal speech rate, the keyword indices refinement engine 940 can use the processing flow 940-2 to refine or fine-tune the estimated KW start and end indices 925 based on the average normal talker keyword length Ln embedded in the model metadata average keyword length information 942. For instance, the keyword indices refinement engine 940 can calculate a normal speech rate fine-tuned keyword length as max {Lₑₛₜ, Lₙ}, and may use the fine-tuned keyword length to adjust one or more (or both) of the estimated KW start and/or the estimated KW end indices 925. For example, if the estimated spoken keyword length Lₑₛₜ determined from the initial KW start and end indices 925 is longer than the average normal talker spoken keyword length Lₙ, the initial estimated KW start and end indices 925 can be used as the refined KW start and end indices output by the keyword indices refinement engine 940 (e.g., the same as or similar to the refined KW start and end indices 845 output by the keyword indices refinement engine 840 of FIG. 8). If the estimated spoken keyword length Lₑₛₜ from the initial KW indices estimate 925 is shorter than the average normal talker spoken keyword length Lₙ, the initial estimated KW start and end indices 925 can be adjusted such that (refined KW end index)−(refined KW start index)=Lₙ.

In some examples, the refined KW start and end indices may each be shifted an equal amount of time from their respective initial KW start and end indices 925. For instance, the refined KW start index can be shifted to be earlier than the initial KW start index 925 by an amount equal to

$$\frac{{L}_{n} - {L}_{e s t}}{2}$$

and the refined KW end index can be shifted to be later than the initial KW end index 925 by an amount also equal

$$\frac{{L}_{n} - {L}_{e s t}}{2}$$

(e.g., for a total increase in refined keyword length of Lₙ−Lₑₛₜ, and a refined keyword length equal to Lₙ). In some cases, the estimated KW start and end indices 925 may be non-proportionally or unequally adjusted to generate the corresponding refined KW start and end indices. For instance, the refined KW start index can be shifted to be earlier than the initial KW start index 925 by an amount equal to N(Lₙ−Lₑₛₜ) and the refined KW end index can be shifted to be later than the initial KW end index 925 by an amount equal to (1−N)(Lₙ−Lₑₛₜ), for a total increase in refined keyword length of Lₙ−Lₑₛₜ, and a refined keyword length equal to Lₙ. In one illustrative example, the weighting parameter N can be between 0.5 and 1 (e.g., as the initial KW end index estimate may be more accurate than the initial KW start index estimate of the estimated indices 925)

In another illustrative example, based on the speech rate classification network 930 generating speech rate classification information (e.g., such as speech rate classification information 835 of FIG. 8) indicative of a fast speech rate, the keyword indices refinement engine 940 can use the processing flow 940-3 to refine or fine-tune the estimated KW start and end indices 925 based on the average fast talker keyword length L_{f} embedded in the model metadata average keyword length information 942. For instance, the keyword indices refinement engine 940 can calculate a fast speech rate fine-tuned keyword length as max {Lₑₛₜ, L_{f}}, and may use the fine-tuned keyword length to adjust one or more (or both) of the estimated KW start and/or the estimated KW end indices 925. For example, if the estimated spoken keyword length Lₑₛₜ determined from the initial KW start and end indices 925 is longer than the average fast talker spoken keyword length L_{f}, the initial estimated KW start and end indices 925 can be used as the refined KW start and end indices output by the keyword indices refinement engine 940 (e.g., the same as or similar to the refined KW start and end indices 845 output by the keyword indices refinement engine 840 of FIG. 8). If the estimated spoken keyword length Lₑₛₜ from the initial indices estimate 925 is shorter than the average fast talker spoken keyword length L_{f}, the initial estimated KW start and end indices 925 can be adjusted such that (refined KW end index)−(refined KW start index)=L_{f}.

In some examples, the refined KW start and end indices may each be shifted an equal amount of time from their respective initial KW start and end indices 925. For instance, the refined KW start index can be shifted to be earlier than the initial KW start index 925 by an amount equal to

$$\frac{{L}_{f} - {L}_{e s t}}{2}$$

and the refined KW end index can be shifted to be later than the initial KW end index 925 by an amount also equal to

$$\frac{{L}_{f} - {L}_{e s t}}{2}$$

(e.g., for a total increase in refined keyword length of L_{f}−Lₑₛₜ, and a refined keyword length equal to L_{f}). In some cases, the estimated KW start and end indices 925 may be non-proportionally or unequally adjusted to generate the corresponding refined KW start and end indices. For instance, the refined KW start index can be shifted to be earlier than the initial KW start index 925 by an amount equal to N(L_{f}−Lₑₛₜ) and the refined KW end index can be shifted to be later than the initial KW end index 925 by an amount equal to (1−N)(L_{f}−Lₑₛₜ), for a total increase in refined keyword length of L_{f}−Lₑₛₜ, and a refined keyword length equal to L_{f}. In one illustrative example, the weighting parameter N can be between 0.5 and 1 (e.g., as the initial KW end index estimate may be more accurate than the initial KW start index estimate of the estimated indices 925)

In some aspects, the systems and techniques described herein can be used to perform keyword length refinement (e.g., keyword start and/or end indices refinement) based on speech rate classification information of an underlying audio sample in which the particular keyword was initially detected. The refined keyword start and end indices (e.g., such as the refined KW start and end indices 845 of FIG. 8, the refined KW start and end indices generated using the keyword indices refinement engine 840 of FIG. 8, etc.) can be used to extend the length of the estimated keyword to more closely correspond to the actual, ground truth keyword start and end time indices. For instance, the refined KW start and end indices 845 of FIG. 8 can correspond to a refinement to shift the initial estimated KW start and end indices 632 and 634 of FIG. 6 to be closer to the respective ground-truth KW start and end indices 602 and 604 of FIG. 6.

In some aspects, refining or fine-tuning the estimated KW start and end indices (e.g., estimated KW start index 825 of FIG. 8, estimated KW start index 925 of FIG. 9, etc.) can reduce the occurrence of keyword chopping in the keyword buffer information representative of a detected keyword passed from a first keyword detection stage to a second keyword detection stage in a multi-stage keyword detection system. The overall keyword detection system performance can be improved based on the addition of the speech rate classification network 830 of FIGS. 8 and/or 930 of FIG. 9, which may be configured to run only when the first keyword detection stage (e.g., KW detection network 812 of FIG. 8) has detected a particular keyword within the currently analyzed input audio sample.

The systems and techniques described herein for keyword length refinement can additionally be used to reduce the amount of excess audio data buffering that is performed in a multi-stage keyword detection system, both pre-keyword estimate and post-keyword estimate. The refined KW start and end indices 845 can be shifted to be nearer to the actual, ground-truth KW start and end indices for the spoken keyword detected within the current audio sample, and using the refined KW start and end indices for subsequent keyword detection and/or keyword processing stages of the multi-stage keyword detection system can reduce processing time and power associated with performing the keyword detection.

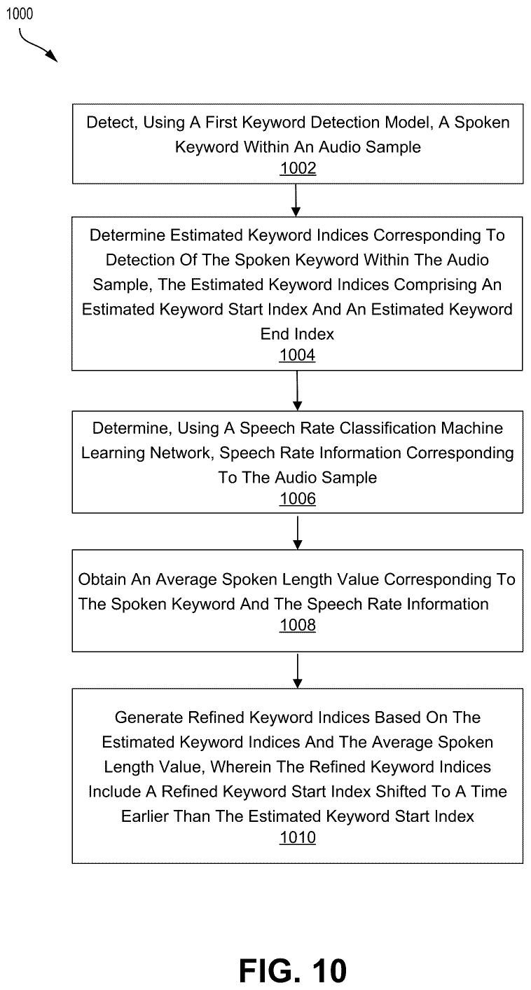

FIG. 10 is a block diagram illustrating a process 1000 for processing one or more audio samples. Although the example process 1000 depicts a particular sequence of operations, the sequence may be altered without departing from the scope of the present disclosure. For example, some of the operations depicted may be performed in parallel or in a different sequence that does not materially affect the function of the process 1000. In other examples, different components of an example device or system that implements the process 1000 may perform functions at substantially the same time or in a specific sequence. In some examples, the process 1000 can be performed by the computing device 100 of FIG. 1, the keyword detection system 200 of FIG. 2, the keyword detection system 800 of FIG. 8, the keyword detection architecture 900 of FIG. 9, etc.

At block 1002, the process 1000 includes detecting, using a first keyword detection model, a spoken keyword within an audio sample of the one or more audio samples. For example, the first keyword detection model can be the same as or similar to one or more of the keyword detection model 212 and/or the keyword detection first stage 200 of FIG. 2; the keyword detection network 812 of FIG. 8; the keyword detection and start estimation system 820 of FIG. 8; etc.

In some cases, the audio sample can be obtained from the audio source 202 of FIG. 2, and/or can be the same as or similar to the audio signal of FIG. 3. In some cases, the audio sample can be the same as or similar to the input speech 802 of FIG. 8. In some cases, the one or more audio samples can be included in the input speech 802 of FIG. 8.

In some examples, the first keyword detection model is configured to perform always-on keyword detection for the one or more audio samples. In some cases, the first keyword detection model can be associated with a speech rate classification machine learning network. For instance, the speech rate classification machine learning network can be the same as or similar to the speech rate classification network 830 of FIG. 8, the speech rate classification network 930 of FIG. 9, etc. In some cases, the speech rate classification machine learning network is configured to perform speech rate classification for a particular audio sample of the one or more audio samples based on detection of the spoken keyword within the particular audio sample by the first keyword detection model. For instance, the speech rate classification machine learning network 830 of FIG. 8 can be configured to perform speech rate classification for a particular audio sample within the input speech 802 based on detection of a spoken keyword within the audio sample of input speech 802 by the first keyword detection model 812 of FIG. 8.

At block 1004, the process 1000 includes determining estimated keyword indices corresponding to detection of the spoken keyword within the audio sample, the estimated keyword indices comprising an estimated keyword start index and an estimated keyword end index.

For instances, the estimated keyword indices can be determined using the keyword detection and start estimation system 820 of FIG. 8 and/or using the keyword start estimation network 816 of FIG. 8. In some examples, the estimated keyword indices can be determined using the keyword detection first stage 200 of FIG. 2. In some instances, the estimated keyword indices can include an estimated keyword start index the same as or similar to the estimated start 632 of FIG. 6 and/or can include an estimated keyword end index the same as or similar to the estimated end 634 of FIG. 6.

At block 1006, the process 1000 includes determining, using a speech rate classification machine learning network, speech rate information corresponding to the audio sample. For example, the speech rate classification machine learning network can be the same as or similar to the speech rate classification network 830 of FIG. 8, the speech rate classification network 930 of FIG. 9, etc.

In some examples, the speech rate information can be the same as or similar to the speech rate information 835 of FIG. 8, which may be determined using the speech rate classification network 830 of FIG. 8. In some examples, the speech rate information can be the same as or similar to the speech rate information 940 of FIG. 9. In some cases, the speech rate information can be selected from a slow speech rate classification the same as or similar to the slow speech rate information 940-1 of FIG. 9, a normal speech rate classification the same as or similar to the normal speech rate information 940-2 of FIG. 9, or a fast speech rate classification the same as or similar to the fast speech rate information 940-3 of FIG. 9.

In some cases, the speech rate information is indicative of a slow speech rate classification (e.g., the same as or similar to slow speech rate 940-1 of FIG. 9), a normal speech rate classification (e.g., the same as or similar to the normal speech rate 940-2 of FIG. 9), or a fast speech rate classification (e.g., the same as or similar to the fast speech rate 940-3 of FIG. 9) for the spoken keyword within the audio sample.

In some examples, the speech rate information and the estimated keyword start index can be determined in parallel. In some cases, the speech rate information can be determined using the speech rate classification machine learning network in response to detection of the spoken keyword (e.g., detection of the spoken keyword by the first keyword detection machine learning network). The estimated keyword start index (e.g., 825 of FIG. 8, 925 of FIG. 9, 632 of FIG. 6, etc.) can be determined using a keyword start estimation neural network in response to detection of the spoken keyword. In some examples, the keyword start estimation neural network can be the same as or similar to the keyword start estimation network 816 of FIG. 8, and can be included in the same keyword detection and start estimation system 820 as the first keyword detection machine learning network 812 used to perform the keyword detection.

For example, the first keyword detection model and the keyword start estimation neural network can be included in a first keyword detection stage of a multi-stage keyword detection system. The first keyword detection stage can be the same as or similar to the first keyword detection stage 200 of FIG. 2, and/or can be the same as or similar to the keyword detection and start estimation system 820 of FIG. 8 and/or the first keyword detection stage 800 of FIG. 8, etc.

At block 1008, the process 1000 includes obtaining an average spoken length value corresponding to the spoken keyword and the speech rate information. For instance, the average spoken length value can be the same as or similar to the average keyword length values 842 of FIG. 8 and/or the average keyword length values 942 of FIG. 9.

In some cases, the average spoken length value is included in average keyword length information corresponding to the spoken keyword (e.g., the average keyword length values 842 of FIG. 8 and/or the average keyword length values 942 of FIG. 9). IN some examples, the average keyword length information includes a respective average spoken length value for each speech rate classification of a plurality of speech rate classifications associated with the speech rate classification machine learning network. For instance, the respective average spoken length values can include the slow speech rate 940-1 average spoken length value Lₛ of 942 of FIG. 9, the normal speech rate 940-2 average spoken length value Lₙ of 942 of FIG. 9, and/or the fast speech rate 940-3 average spoken length value L_{f} of 942 of FIG. 9.

In some cases, the average keyword length information comprises offline estimations of the respective average spoken length values. For instance, the slow speech rate 940-1 average spoken length value Lₛ of 942 of FIG. 9 can correspond to an offline estimation 730 of FIG. 7 for a slow talker. The normal speech rate 940-2 average spoken length value Lₙ of 942 of FIG. 9 can correspond to an offline estimation 720 of FIG. 7 for a normal talker. The fast speech rate 940-3 average spoken length value L_{f} of 942 of FIG. 9 can correspond to an offline estimation 710 of FIG. 7 for a fast talker.

In some cases, each respective average spoken length value included in the average keyword length information is embedded in machine learning model metadata associated with a configuration of the speech rate classification machine learning network or a configuration of a keyword indices refinement machine learning network used to generate the refined keyword indices. For instance, the average keyword spoken length values 842 of FIG. 8 can be embedded in machine learning model metadata associated with a configuration of the speech rate classification network 830 of FIG. 8 and/or embedded in machine learning model metadata associated with a configuration of the keyword indices refinement machine learning network (e.g., engine) 840 of FIG. 8.

At block 1010, the process 1000 includes generating refined keyword indices based on the estimated keyword indices and the average spoken length value, wherein the refined keyword indices include a refined keyword start index shifted to a time earlier than the estimated keyword start index and a refined keyword end index shifted to a time later than the estimated keyword end index. For instance, the refined keyword indices can be the same as or similar to the refined keyword indices 845 of FIG. 8. In some examples, the refined keyword indices include a refined keyword start index corresponding to the estimated keyword start index 825 determined by the keyword start estimation network 816 of FIG. 8. In some cases, a refined keyword start index can be the same as or similar to an actual or ground truth keyword start index, such as the actual (ground truth) keyword start index 602 of FIG. 6 (e.g., relative to the estimated keyword start index 632 of FIG. 6). In some examples, a refined keyword end index can be the same as or similar to an actual or ground truth keyword end index, such as the actual (ground truth) keyword end index 604 of FIG. 6 (e.g., relative to the estimated keyword end index 634 of FIG. 6).

In some cases, the refined keyword indices can be generated based on determining an estimated length for the spoken keyword, based on a difference between the estimated keyword end index and the estimated keyword start index. For instance, the estimated length can correspond to a difference between the estimated keyword end index 634 of FIG. 6 and the estimated keyword start index 632 of FIG. 6.

In some examples, the estimated length for the spoken keyword can be compared to the average spoken length value for the keyword to determine a refined length for the spoken keyword. For instance, the comparison can be performed using the speech rate classification network 840 of FIG. 8 and/or the speech rate classification network 930 of FIG. 9. For example, the estimated length for the spoken keyword can be the same as or similar to the estimated keyword length Lₑₛₜ of FIG. 9, and the comparison can be between Lₑₛₜ and Lₛ for the slow speech rate 940-1, between Lₑₛₜ and Lₙ for the normal speech rate 940-2, or between Lₑₛₜ and the fast speech rate 940-3, etc. In some cases, the refined keyword indices (e.g., refined keyword indices 845 of FIG. 8) can be generated based on the refined length for the spoken keyword.

In some cases, the refined keyword indices can be generated based on determining the refined keyword start index as a time index shifted earlier than the estimated keyword start index by a first amount corresponding to a difference between the refined length and the estimated length for the spoken keyword. The refined keyword end index can be determined as a time index shifted later than the estimated keyword end index by a second amount corresponding to the difference between the refined length and the estimated length for the spoken keyword.

In some cases, the first amount and the second amount are the same. In some examples, the first amount comprises a first percentage of the difference between the refined length and the estimated length for the spoken keyword. In some cases, the second amount comprises a second percentage of the difference between the refined length and the estimated length for the spoken keyword. In some examples, the first percentage is greater than the second percentage. In some cases, the first percentage is greater than 50%, and wherein a sum of the first percentage and the second percentage is equal to 100%.

In some cases, an apparatus used to implement the process 1000 can include microphone configured to obtain the one or more audio samples. In some cases, the apparatus further comprises one or more microphones configured to capture the one or more audio samples for keyword detection. In some examples, the one or more microphones and the first keyword detection model are associated with an always-on keyword detection process implemented by the apparatus.

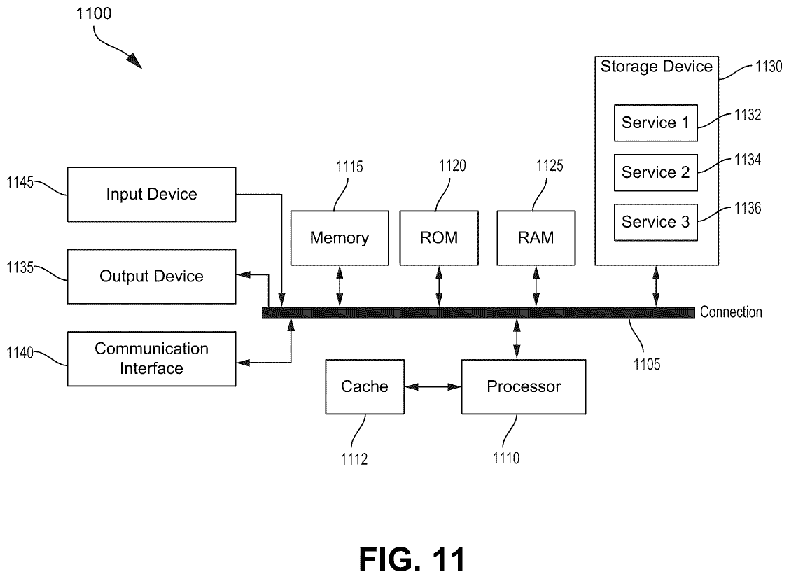

In some cases, the processes described herein (e.g., the process 1000 and/or any other process described herein) may be performed by a computing device or apparatus. In one example, the process 1000 and/or other technique or process described herein can be performed by the system of FIG. 8 and/or FIG. 9. In another example, the process 1000 and/or other technique or process described herein can be performed by the computing system 1100 shown in FIG. 11. For instance, a computing device with the computing device architecture of the computing system 1100 shown in FIG. 11 can implement the operations of the process 1000, and/or can implement one or more of the components and/or operations described herein with respect to any of FIGS. 1 through 9.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 1000 is illustrated as a logical flow diagram, the operation of which represents a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 1000 and/or other process described herein, may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 11 is a diagram illustrating an example of a system for implementing certain aspects of the present technology. In particular, FIG. 11 illustrates an example of computing system 1100, which may be for example any computing device making up internal computing system, a remote computing system, a camera, or any component thereof in which the components of the system are in communication with each other using connection 1105. Connection 1105 may be a physical connection using a bus, or a direct connection into processor 1110, such as in a chipset architecture. Connection 1105 may also be a virtual connection, networked connection, or logical connection.

In some aspects, computing system 1100 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 1100 includes at least one processing unit (CPU or processor) 1110 and connection 1105 that communicatively couples various system components including system memory 1115, such as read-only memory (ROM) 1120 and random access memory (RAM) 1125 to processor 1110. Computing system 1100 may include a cache 1115 of high-speed memory connected directly with, in close proximity to, or integrated as part of processor 1110.

Processor 1110 may include any general-purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which may represent any number of input mechanisms, such as a microphone for speech, a touch-sensitive screen for gesture or graphical input, keyboard, mouse, motion input, speech, etc. Computing system 1100 may also include output device 1135, which may be one or more of a number of output mechanisms. In some instances, multimodal systems may enable a user to provide multiple types of input/output to communicate with computing system 1100.

Computing system 1100 may include communications interface 1140, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1130 may include software services, servers, services, etc., that when the code that defines such software is executed by the processor 1110, it causes the system to perform a function. In some aspects, a hardware service that performs a particular function may include the software component stored in a computer-readable medium in connection with the necessary hardware components, such as processor 1110, connection 1105, output device 1135, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus for processing one or more audio samples, comprising: one or more memories configured to store the one or more audio samples; and one or more processors coupled to the one or more memories, the one or more processors being configured to: detect, using a first keyword detection model, a spoken keyword within an audio sample of the one or more audio samples; determine estimated keyword indices corresponding to detection of the spoken keyword within the audio sample, the estimated keyword indices comprising an estimated keyword start index and an estimated keyword end index; determine, using a speech rate classification machine learning network, speech rate information corresponding to the audio sample; obtain an average spoken length value corresponding to the spoken keyword and the speech rate information; and generate refined keyword indices based on the estimated keyword indices and the average spoken length value, wherein the refined keyword indices include a refined keyword start index shifted to a time earlier than the estimated keyword start index.

Aspect 2. The apparatus of Aspect 1, wherein the speech rate information is indicative of a slow speech rate classification, a normal speech rate classification, or a fast speech rate classification for the spoken keyword within the audio sample.

Aspect 3. The apparatus of any of Aspects 1 to 2, wherein the one or more processors are configured to determine the speech rate information and determine the estimated keyword start index in parallel.

Aspect 4. The apparatus of any of Aspects 1 to 3, wherein the one or more processors are configured to: determine the speech rate information using the speech rate classification machine learning network in response to detection of the spoken keyword; and determine the estimated keyword start index using a keyword start estimation neural network in response to detection of the spoken keyword.

Aspect 5. The apparatus of Aspect 4, wherein: the first keyword detection model and the keyword start estimation neural network are included in a first keyword detection stage of a multi-stage keyword detection system.

Aspect 6. The apparatus of any of Aspects 1 to 5, wherein: the first keyword detection model is configured to perform always-on keyword detection for one or more audio samples; and the speech rate classification machine learning network is configured to perform speech rate classification for a particular audio sample of the one or more audio samples based on detection of the spoken keyword within the particular audio sample by the first keyword detection model.

Aspect 7. The apparatus of any of Aspects 1 to 6, wherein: the average spoken length value is included in average keyword length information corresponding to the spoken keyword; and the average keyword length information includes a respective average spoken length value for each speech rate classification of a plurality of speech rate classifications associated with the speech rate classification machine learning network.

Aspect 8. The apparatus of Aspect 7, wherein the average keyword length information comprises offline estimations of the respective average spoken length values.

Aspect 9. The apparatus of any of Aspects 7 to 8, wherein each respective average spoken length value included in the average keyword length information is embedded in machine learning model metadata associated with a configuration of the speech rate classification machine learning network or a configuration of a keyword indices refinement machine learning network used to generate the refined keyword indices.

Aspect 10. The apparatus of any of Aspects 1 to 9, wherein, to generate the refined keyword indices, the one or more processors are configured to: determine an estimated length for the spoken keyword, based on a difference between the estimated keyword end index and the estimated keyword start index; compare the estimated length to the average spoken length value to determine a refined length for the spoken keyword; and generate the refined keyword indices based on the refined length for the spoken keyword.

Aspect 11. The apparatus of Aspect 10, wherein, to generate the refined keyword indices, the one or more processors are configured to: determine the refined keyword start index as a time index shifted earlier than the estimated keyword start index by a first amount corresponding to a difference between the refined length and the estimated length for the spoken keyword; and determine a refined keyword end index as a time index shifted later than the estimated keyword end index by a second amount corresponding to the difference between the refined length and the estimated length for the spoken keyword.

Aspect 12. The apparatus of Aspect 11, wherein the first amount and the second amount are the same.

Aspect 13. The apparatus of any of Aspects 11 to 12, wherein: the first amount comprises a first percentage of the difference between the refined length and the estimated length for the spoken keyword; and the second amount comprises a second percentage of the difference between the refined length and the estimated length for the spoken keyword.

Aspect 14. The apparatus of Aspect 13, wherein the first percentage is greater than the second percentage.

Aspect 15. The apparatus of any of Aspects 13 to 14, wherein the first percentage is greater than 50%, and wherein a sum of the first percentage and the second percentage is equal to 100%.

Aspect 16. The apparatus of any of Aspects 1 to 15, further comprising a microphone configured to obtain the one or more audio samples.

Aspect 17. The apparatus of any of Aspects 1 to 16, further comprising: one or more microphones configured to capture the one or more audio samples for keyword detection.

Aspect 18. The apparatus of Aspect 17, wherein the one or more microphones and the first keyword detection model are associated with an always-on keyword detection process implemented by the apparatus.

Aspect 19. A processor-implemented method for processing one or more audio samples, comprising: detecting, using a first keyword detection model, a spoken keyword within an audio sample of the one or more audio samples; determining estimated keyword indices corresponding to detection of the spoken keyword within the audio sample, the estimated keyword indices comprising an estimated keyword start index and an estimated keyword end index; determining, using a speech rate classification machine learning network, speech rate information corresponding to the audio sample; obtaining an average spoken length value corresponding to the spoken keyword and the speech rate information; and generating refined keyword indices based on the estimated keyword indices and the average spoken length value, wherein the refined keyword indices include a refined keyword start index shifted to a time earlier than the estimated keyword start index.

Aspect 20. The processor-implemented method of Aspect 19, wherein the speech rate information is indicative of a slow speech rate classification, a normal speech rate classification, or a fast speech rate classification for the spoken keyword within the audio sample.

Aspect 21. The processor-implemented method of any of Aspects 19 to 20, further comprising determining the speech rate information and the estimated keyword start index in parallel.

Aspect 22. The processor-implemented method of any of Aspects 19 to 21, further comprising: determining the speech rate information using the speech rate classification machine learning network in response to detection of the spoken keyword; and determining the estimated keyword start index using a keyword start estimation neural network in response to detection of the spoken keyword.

Aspect 23. The processor-implemented method of Aspect 22, wherein: the first keyword detection model and the keyword start estimation neural network are included in a first keyword detection stage of a multi-stage keyword detection system.

Aspect 24. The processor-implemented method of any of Aspects 19 to 23, wherein: the first keyword detection model is configured to perform always-on keyword detection for one or more audio samples; and the speech rate classification machine learning network is configured to perform speech rate classification for a particular audio sample of the one or more audio samples based on detection of the spoken keyword within the particular audio sample by the first keyword detection model.

Aspect 25. The processor-implemented method of any of Aspects 19 to 24, wherein: the average spoken length value is included in average keyword length information corresponding to the spoken keyword; and the average keyword length information includes a respective average spoken length value for each speech rate classification of a plurality of speech rate classifications associated with the speech rate classification machine learning network.

Aspect 26. The processor-implemented method of Aspect 25, wherein the average keyword length information comprises offline estimations of the respective average spoken length values.

Aspect 27. The processor-implemented method of any of Aspects 25 to 26, wherein each respective average spoken length value included in the average keyword length information is embedded in machine learning model metadata associated with a configuration of the speech rate classification machine learning network or a configuration of a keyword indices refinement machine learning network used to generate the refined keyword indices.

Aspect 28. The processor-implemented method of any of Aspects 19 to 27, wherein generating the refined keyword indices comprises: determining an estimated length for the spoken keyword, based on a difference between the estimated keyword end index and the estimated keyword start index; comparing the estimated length to the average spoken length value to determine a refined length for the spoken keyword; and generating the refined keyword indices based on the refined length for the spoken keyword.

Aspect 29. The processor-implemented method of Aspect 28, wherein generating the refined keyword indices comprises: determining the refined keyword start index as a time index shifted earlier than the estimated keyword start index by a first amount corresponding to a difference between the refined length and the estimated length for the spoken keyword; and determining a refined keyword end index as a time index shifted later than the estimated keyword end index by a second amount corresponding to the difference between the refined length and the estimated length for the spoken keyword.

Aspect 30. The processor-implemented method of Aspect 29, wherein the first amount and the second amount are the same.

Aspect 31. The processor-implemented method of any of Aspects 29 to 30, wherein: the first amount comprises a first percentage of the difference between the refined length and the estimated length for the spoken keyword; and the second amount comprises a second percentage of the difference between the refined length and the estimated length for the spoken keyword.

Aspect 32. The processor-implemented method of Aspect 31, wherein the first percentage is greater than the second percentage.

Aspect 33. The processor-implemented method of any of Aspects 31 to 32, wherein the first percentage is greater than 50%, and wherein a sum of the first percentage and the second percentage is equal to 100%.

Aspect 34. A non-transitory computer-readable storage medium comprising instructions stored thereon which, when executed by at least one processor, causes the at least one processor to perform operations according to any of Aspects 1 to 18.

Aspect 35. A non-transitory computer-readable storage medium comprising instructions stored thereon which, when executed by at least one processor, causes the at least one processor to perform operations according to any of Aspects 19 to 33.

Aspect 36. An apparatus comprising one or more means for performing operations according to any of Aspects 1 to 18.

Aspect 37. An apparatus comprising one or more means for performing operations according to any of Aspects 19 to 33.

What is claimed is:

1. An apparatus for processing one or more audio samples, comprising:
one or more memories configured to store the one or more audio samples; and
one or more processors coupled to the one or more memories, the one or more processors being configured to:
detect, using a first keyword detection model, a spoken keyword within an audio sample of the one or more audio samples;
determine estimated keyword indices corresponding to detection of the spoken keyword within the audio sample, the estimated keyword indices comprising an estimated keyword start index and an estimated keyword end index;
determine, using a speech rate classification machine learning network, speech rate information corresponding to the audio sample;
obtain an average spoken length value corresponding to the spoken keyword and the speech rate information; and
generate refined keyword indices based on the estimated keyword indices and the average spoken length value, wherein the refined keyword indices include a refined keyword start index shifted to a time earlier than the estimated keyword start index.

2. The apparatus of claim 1, wherein the speech rate information is indicative of a slow speech rate classification, a normal speech rate classification, or a fast speech rate classification for the spoken keyword within the audio sample.

3. The apparatus of claim 1, wherein the one or more processors are configured to determine the speech rate information and determine the estimated keyword start index in parallel.

4. The apparatus of claim 1, wherein the one or more processors are configured to:
determine the speech rate information using the speech rate classification machine learning network in response to detection of the spoken keyword; and
determine the estimated keyword start index using a keyword start estimation neural network in response to detection of the spoken keyword.

5. The apparatus of claim 4, wherein:
the first keyword detection model and the keyword start estimation neural network are included in a first keyword detection stage of a multi-stage keyword detection system.

6. The apparatus of claim 1, wherein:
the first keyword detection model is configured to perform always-on keyword detection for one or more audio samples; and
the speech rate classification machine learning network is configured to perform speech rate classification for a particular audio sample of the one or more audio samples based on detection of the spoken keyword within the particular audio sample by the first keyword detection model.

7. The apparatus of claim 1, wherein:
the average spoken length value is included in average keyword length information corresponding to the spoken keyword; and
the average keyword length information includes a respective average spoken length value for each speech rate classification of a plurality of speech rate classifications associated with the speech rate classification machine learning network.

8. The apparatus of claim 7, wherein the average keyword length information comprises offline estimations of the respective average spoken length values.

9. The apparatus of claim 7, wherein each respective average spoken length value included in the average keyword length information is embedded in machine learning model metadata associated with a configuration of the speech rate classification machine learning network or a configuration of a keyword indices refinement machine learning network used to generate the refined keyword indices.

10. The apparatus of claim 1, wherein, to generate the refined keyword indices, the one or more processors are configured to:
determine an estimated length for the spoken keyword, based on a difference between the estimated keyword end index and the estimated keyword start index;
compare the estimated length to the average spoken length value to determine a refined length for the spoken keyword; and
generate the refined keyword indices based on the refined length for the spoken keyword.

11. The apparatus of claim 10, wherein, to generate the refined keyword indices, the one or more processors are configured to:
determine the refined keyword start index as a time index shifted earlier than the estimated keyword start index by a first amount corresponding to a difference between the refined length and the estimated length for the spoken keyword; and
determine a refined keyword end index as a time index shifted later than the estimated keyword end index by a second amount corresponding to the difference between the refined length and the estimated length for the spoken keyword.

12. The apparatus of claim 11, wherein the first amount and the second amount are the same.

13. The apparatus of claim 11, wherein:
the first amount comprises a first percentage of the difference between the refined length and the estimated length for the spoken keyword; and
the second amount comprises a second percentage of the difference between the refined length and the estimated length for the spoken keyword.

14. The apparatus of claim 13, wherein the first percentage is greater than the second percentage.

15. The apparatus of claim 13, wherein the first percentage is greater than 50%, and wherein a sum of the first percentage and the second percentage is equal to 100%.

16. The apparatus of claim 1, further comprising a microphone configured to obtain the one or more audio samples.

17. The apparatus of claim 1, further comprising:
one or more microphones configured to capture the one or more audio samples for keyword detection.

18. The apparatus of claim 17, wherein the one or more microphones and the first keyword detection model are associated with an always-on keyword detection process implemented by the apparatus.

19. A processor-implemented method for processing one or more audio samples, comprising:
detecting, using a first keyword detection model, a spoken keyword within an audio sample of the one or more audio samples;
determining estimated keyword indices corresponding to detection of the spoken keyword within the audio sample, the estimated keyword indices comprising an estimated keyword start index and an estimated keyword end index;
determining, using a speech rate classification machine learning network, speech rate information corresponding to the audio sample;
obtaining an average spoken length value corresponding to the spoken keyword and the speech rate information; and
generating refined keyword indices based on the estimated keyword indices and the average spoken length value, wherein the refined keyword indices include a refined keyword start index shifted to a time earlier than the estimated keyword start index.

20. The processor-implemented method of claim 19, wherein the speech rate information is indicative of a slow speech rate classification, a normal speech rate classification, or a fast speech rate classification for the spoken keyword within the audio sample.

21. The processor-implemented method of claim 19, further comprising determining the speech rate information and the estimated keyword start index in parallel.

22. The processor-implemented method of claim 19, further comprising:
determining the speech rate information using the speech rate classification machine learning network in response to detection of the spoken keyword; and
determining the estimated keyword start index using a keyword start estimation neural network in response to detection of the spoken keyword.

23. The processor-implemented method of claim 22, wherein:
the first keyword detection model and the keyword start estimation neural network are included in a first keyword detection stage of a multi-stage keyword detection system.

24. The processor-implemented method of claim 19, wherein:
the first keyword detection model is configured to perform always-on keyword detection for one or more audio samples; and
the speech rate classification machine learning network is configured to perform speech rate classification for a particular audio sample of the one or more audio samples based on detection of the spoken keyword within the particular audio sample by the first keyword detection model.

25. The processor-implemented method of claim 19, wherein:
the average spoken length value is included in average keyword length information corresponding to the spoken keyword; and
the average keyword length information includes a respective average spoken length value for each speech rate classification of a plurality of speech rate classifications associated with the speech rate classification machine learning network.

26. The processor-implemented method of claim 25, wherein the average keyword length information comprises offline estimations of the respective average spoken length values.

27. The processor-implemented method of claim 25, wherein each respective average spoken length value included in the average keyword length information is embedded in machine learning model metadata associated with a configuration of the speech rate classification machine learning network or a configuration of a keyword indices refinement machine learning network used to generate the refined keyword indices.

28. The processor-implemented method of claim 19, wherein generating the refined keyword indices comprises:
determining an estimated length for the spoken keyword, based on a difference between the estimated keyword end index and the estimated keyword start index;
comparing the estimated length to the average spoken length value to determine a refined length for the spoken keyword; and
generating the refined keyword indices based on the refined length for the spoken keyword.

29. The processor-implemented method of claim 28, wherein generating the refined keyword indices comprises:
determining the refined keyword start index as a time index shifted earlier than the estimated keyword start index by a first amount corresponding to a difference between the refined length and the estimated length for the spoken keyword; and
determining a refined keyword end index as a time index shifted later than the estimated keyword end index by a second amount corresponding to the difference between the refined length and the estimated length for the spoken keyword.

30. The processor-implemented method of claim 29, wherein the first amount and the second amount are the same, and wherein:
the first amount comprises a first percentage of the difference between the refined length and the estimated length for the spoken keyword; and
the second amount comprises a second percentage of the difference between the refined length and the estimated length for the spoken keyword.
